(19) United States
(12) Patent Application Publication
(10) Pub. No.: US 2025/0048181 A1
(43) Pub. Date: Feb. 6, 2025

(54) METHOD AND DEVICE FOR WIRELESS COMMUNICATION

(71) Applicants: Yu CHEN, Shanghai (CN); Xiaobo ZHANG, Shanghai (CN)

(72) Inventors: Yu CHEN, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/921,037

(22) Filed: Oct. 21, 2024

Related U.S. Application Data
(63) Continuation of application No. PCT/CN2023/091014, filed on Apr. 27, 2023.

(30) Foreign Application Priority Data
Apr. 30, 2022 (CN) 202210476674.3

(51) Int. Cl. H04W 28/06; H04W 28/02

(52) U.S. Cl. CPC H04W 28/06; H04W 28/0252

(57) ABSTRACT

The present application discloses a method and a device for wireless communications, including: performing a first operation for a first data packet at a first protocol layer, the first operation being receiving or the first operation being transmitting; as a response to the action of performing the first operation, starting a first timer, and as a response to expiration of the first timer, performing a second operation for at least second data packet in a first data packet set at the first protocol layer; the second operation being submitting to a protocol layer other than the first protocol layer, or the second operation being discarding. This application offers the possibility of transmitting richer and more complex services through the first operation and second operation.

### CROSS REFERENCE TO RELATED APPLICATIONS

This application is the continuation of the international patent application No. PCT/CN2023/091014, filed on Apr. 27,2023, and claims the priority benefit of Chinese Patent Application No. 202210476674.3, filed on Apr. 30,2022, the full disclosure of which is incorporated herein by reference.

### BACKGROUND

### Technical Field

The present application relates to transmission methods and devices in wireless communication systems concerning the enhancement of Quality of Services (QoS) and interactive traffic transmission, and in particular to a method and a device for XR services.

### Related Art

Application scenarios of future wireless communication systems are becoming increasingly diversified, and different application scenarios have different performance demands on systems. In order to meet different performance requirements of various application scenarios, the 3rd Generation Partner Project (3GPP) Radio Access Network (RAN) #72 plenary decided to conduct the study of New Radio (NR), or what is called fifth Generation (5G). The work Item (WI) of NR was approved at the 3GPP RAN #75 plenary to standardize the NR.

In communications, both Long Term Evolution (LTE) and 5G NR involves correct reception of reliable information, optimized energy efficiency ratio (EER), determination of information validity, flexible resource allocation, elastic system structure, effective information processing on non-access stratum (NAS), and lower traffic interruption and call drop rate, and support to lower power consumption, which play an important role in the normal communication between a base station and a User Equipment (UE), rational scheduling of resources, and also in the balance of system payload, thus laying a solid foundation for increasing throughput, meeting a variety of traffic needs in communications, enhancing the spectrum utilization and improving service quality. Therefore, LTE and 5G are indispensable no matter in enhanced Mobile BroadBand (eMBB), Ultra Reliable Low Latency Communication (URLLC) or enhanced Machine Type Communication (eMTC). And a wide range of requests can be found in terms of Industrial Internet of Things (IIoT), Vehicular to X (V2X), and Device to Device (D2D), Unlicensed Spectrum communications, and monitoring on UE communication quality, network plan optimization, Non-Terrestrial Network (NTN) and Terrestrial Network (TN), Dual connectivity system, radio resource management and multi-antenna codebook selection, as well as signaling design, neighbor management, traffic management and beamforming. Information is generally transmitted by broadcast and unicast, and both ways are beneficial to fulfilling the above requests and make up an integral part of the 5G system. The UE can be connected to the network either directly or via a relay connection.

As the number and complexity of system scenarios increases, more and more requests have been made on reducing interruption rate and latency, strengthening reliability and system stability, increasing the traffic flexibility and power conservation, and in the meantime the compatibility between different versions of systems shall be taken into account for system designing.

The 3GPP standardization organization has worked on 5G standardization to formulate a series of specifications, of which the details can refer to:
https://www.3gpp.org/ftp/Specs/archive/38_series/38.211/38211-g60.zip
https://www.3gpp.org/ftp/Specs/archive/38_series/38.213/38213-g60.zip
https://www.3gpp.org/ftp/Specs/archive/38_series/38.331/38331-g60.zip
https://www.3gpp.org/ftp/Specs/archive/38_series/38.331/38323-g60.zip

### SUMMARY

As an important concept in communication systems, the Quality of Service (QOS) of services needs to be guaranteed for any kind of communication system. Some services have rather loose QoS requirements, but some may have more stringent QoS requirements and an extra mechanism will be required to guarantee these services, such as XR services. The XR services including VR service, AR service and CG service, featured with high rate and low delay, are also interactive services that are demanding on the time of response of services, for instance, the information of gestures of a user is conveyed to a server, and the images reflected by the server need to be screened on the user's terminal in a very short time, otherwise, the user will sense an obvious delay and the user experience will be influenced. An XR service contains all kinds of data, like video, audio or data used for controlling various sensors, which may be partially dependent on each other. For example, when receiving only a video for the left eye but not receiving a video for the right eye, such transmission will be insufficient for satisfying the requirement, so it may be assumed that at least half of data has been received in conventional service transmission, while in XR service only receiving the video for the left eye may be senseless. Such mutually associated data constitute a set of data that need to be processed as a whole. These data that need to be processed together can be in one flow or multiple flows. The data being correlated may be uplink or downlink. In current 5G access networks, data packets are processed independently and generally have little correlation or dependency with each other, making it difficult to meet the needs of XR services. This is the problem to be addressed by this application. Of course, the method proposed in the present application can solve multifaceted problems and is not limited to XR services.

To address the problem presented above, the present application provides a solution.

It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

The present application provides a method in a first node for wireless communications, comprising:

performing a first operation for a first data packet at a first protocol layer, the first operation being receiving, or the first operation being transmitting: as a response to the action of performing the first operation, starting a first timer, and as a response to expiration of the first timer, performing a second operation for at least second data packet in a first data packet set at the first protocol layer: the second operation being submitting to a protocol layer other than the first protocol layer, or the second operation being discarding:

herein, the first data packet is different from the second data packet: the first data packet and any data packet in the first data packet set are data packets for a user plane; and the first data packet and any data packet in the first data packet set are both generated at the first protocol layer: the first protocol layer is a protocol layer above a Media Access Control (MAC) layer: at least part of bits of the first data packet are transmitted via a Data Radio Bearer (DRB).

In one embodiment, a problem to be solved in the present application includes: how to support the processing of user-plane packets having correlated relationships.

In one embodiment, the benefits of the above method include: increasing the flexibility of wireless transmission and helping to support richer services.

Specifically, according to one aspect of the present application, whether the first operation is receiving or transmitting is used to determine the second operation: when the first operation is receiving, the second operation is submitting to a second protocol layer: when the first operation is transmitting, the second operation is submitting to a third protocol layer or discarding.

Specifically, according to one aspect of the present application, the first data packet and the second data packet use different Data Radio Bearers (DRBs).

Specifically; according to one aspect of the present application, the first data packet includes a first identifier: a target data packet is any data packet in the first data packet set, and whether the target data packet includes the first identifier is used to determine whether to perform the second operation for the target data packet: when the target data packet includes the first identifier, the second operation is performed for the target data packet: when the target data packet does not include the first identifier, the second operation is not performed for the target data packet.

Specifically, according to one aspect of the present application, receiving first information, the first information being used to indicate data packets included in the first data packet set.

Specifically, according to one aspect of the present application, the time of expiration of the first timer is related to either of the time of transmission of the second data packet or the time of arrival of a SDU of the second data packet.

Specifically; according to one aspect of the present application, transmitting second information, the second information being used to indicate data packets included in the first data packet set.

Specifically, according to one aspect of the present application, receiving third information, the third information indicating a first radio bearer set, the first radio bearer set including at least one radio bearer, the first radio bearer set being used to determine the first data packet set.

Specifically, according to one aspect of the present application, the first node is a terminal of Internet of Things (IoT).

Specifically, according to one aspect of the present application, the first node is a relay.

Specifically, according to one aspect of the present application, the first node is a base station.

Specifically, according to one aspect of the present application, the first node is an access-network device.

Specifically, according to one aspect of the present application, the first node is a vehicle-mounted terminal.

Specifically, according to one aspect of the present application, the first node is an aircraft.

Specifically, according to one aspect of the present application, the first node is a cellphone.

The present application provides a first node for wireless communications, comprising: a first processor, performing a first operation for a first data packet at a first protocol layer, the first operation being receiving, or the first operation being transmitting: as a response to the action of performing the first operation, starting a first timer, and as a response to expiration of the first timer, performing a second operation for at least second data packet in a first data packet set at the first protocol layer: the second operation being submitting to a protocol layer other than the first protocol layer, or the second operation being discarding:

herein, the first data packet is different from the second data packet; the first data packet and any data packet in the first data packet set are data packets for a user plane; and the first data packet and any data packet in the first data packet set are both generated at the first protocol layer; the first protocol layer is a protocol layer above a Media Access Control (MAC) layer; at least part of bits of the first data packet are transmitted via a Data Radio Bearer (DRB).

In one embodiment, compared with the prior art, the present application is advantageous in the following aspects:

supporting more diverse service types, such as XR service. enhancing the flexibility of the network.

better meeting requirements for XR services.

supporting the processing of user-plane packets that are mutually correlated and/or dependent on each

other.

supporting deep optimization for the characteristics and content of the services borne by the packets. streamlining the design of nodes and reducing signaling overhead.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of performing a first operation at a first protocol layer against a first data packet, starting a first timer, and performing a second operation against at least second packet in a first data packet set, according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of radio signal transmission according to one embodiment of the present application.

FIG. 6 illustrates a flowchart of radio signal transmission according to one embodiment of the present application.

FIG. 7 illustrates a schematic diagram of a first data packet set according to one embodiment of the present application.

FIG. 8 illustrates a schematic diagram of first information being used to indicate data packets included in a first data packet set according to one embodiment of the present application.

FIG. 9 illustrates a schematic diagram of second information being used to indicate data packets included in a first data packet set according to one embodiment of the present application.

FIG. 10 illustrates a schematic diagram of a first radio bearer set being used to determine a first data packet set according to one embodiment of the present application.

FIG. 11 illustrates a structure block diagram of a processing device in a first node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a flowchart of performing a first operation at a first protocol layer against a first data packet, starting a first timer, and performing a second operation against at least second packet in a first data packet set, according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, the first node of this application performs a first operation at a first protocol layer for a first data packet in step 101: starts a first timer in step 102; and performs a second operation for at least second data packet in a first data packet set in step 103:

herein, the first operation is receiving, or the first operation is transmitting: as a response to the action of performing the first operation, starting a first timer, and as a response to expiration of the first timer, performing a second operation for at least second data packet in a first data packet set at the first protocol layer: the second operation being submitting to a protocol layer other than the first protocol layer, or the second operation being discarding: the first data packet is different from the second data packet: the first data packet and any data packet in the first data packet set are data packets for a user plane; and the first data packet and any data packet in the first data packet set are both generated at the first protocol layer; the first protocol layer is a protocol layer above a Media Access Control (MAC) layer; at least part of bits of the first data packet are transmitted via a Data Radio Bearer (DRB).

In one embodiment, the first node is a User Equipment (UE).

In one embodiment, the first node is a node in RAN.

In one embodiment, the first node is in an RRC connected state.

In one embodiment, the first node is in an RRC inactive state.

In one embodiment, the MAC of the first node is not reset.

In one embodiment, no radio link failure has occurred at the first node.

In one embodiment, the first node has not undergone a switchover.

In one embodiment, no handover failure has occurred at the first node.

In one embodiment, no RRC re-establishment has occurred at the first node.

In one embodiment, the DRB of the first node is not suspending.

In one embodiment, the DRB of the first node for transmitting the first data packet is not suspending.

In one embodiment, the DRB of the first node for transmitting the first data packet is not released.

In one embodiment, the first data packet is a PDU.

In one embodiment, the first data packet is a PDCP PDU.

In one embodiment, the first data packet is a PDCP SDU.

In one embodiment, the first data packet is an SDAP PDU.

In one embodiment, the first data packet is an SDAP SDU.

In one embodiment, the first data packet is an IP packet.

In one embodiment, the first data packet is an IP packet's payload.

In one embodiment, the first data packet is a PDU's payload.

In one embodiment, the first data packet is an SDU.

In one embodiment, the first data packet is an application layer PDU.

In one embodiment, the first data packet is a Non-Access-Stratum PDU.

In one embodiment, the first data packet is an RLC PDU.

In one embodiment, the first data packet is a PDU above a MAC layer.

In one embodiment, the first data packet is a PDU of a Uu interface.

In one embodiment, the first data packet is a PDU of a PC5 interface.

In one embodiment, the first data packet is a PDU on the sidelink.

In one embodiment, the first data packet is a slice.

In one embodiment, any data packet in the first data packet set is a slice.

In one embodiment, the first data packet set includes the first data packet.

In one embodiment, the first data packet set includes only packets other than the first data packet.

In one embodiment, the first data packet set does not include the first data packet.

In one embodiment, the first data packet set includes only the second data packet.

In one embodiment, the first data packet set includes a finite number of packets.

In one embodiment, the first protocol layer is a higher layer of the protocol layer other than the first protocol layer.

In one embodiment, the first protocol layer is a higher layer of the protocol layer other than the first protocol layer.

In one embodiment, a peer protocol layer of the first protocol layer and a peer protocol layer of the protocol layer other than the first protocol layer are in a same network node.

In one embodiment, a peer protocol layer of the first protocol layer and a peer protocol layer of the protocol layer other than the first protocol layer are not in a same network node.

In one embodiment, the first data packet and the second data packet are generated by a same protocol entity:

In one embodiment, the first data packet and the second data packet are generated by different protocol entities.

In one embodiment, any data packet in the first data packet set is generated by the same protocol entity:

In one embodiment, the first data packet set includes at least two data packets being generated by different protocol entities.

In one embodiment, the first data packet and any data packet in the first data packet set are generated by a same protocol entity.

In one embodiment, the first data packet and any data packet in the first data packet set are generated by different protocol entities.

In one embodiment, the first protocol layer is a PDCP layer.

In one embodiment, the first protocol layer is an SDAP layer.

In one embodiment, the first protocol layer is a TCP, UDP or RTP layer.

In one embodiment, the first protocol layer is an IP layer.

In one embodiment, the first protocol layer is a TNL layer.

In one embodiment, the first protocol layer is an RLC layer.

In one embodiment, the first protocol layer is a Non-Access-Stratum (NAS).

In one embodiment, the first protocol layer is an application layer.

In one embodiment, the protocol layer other than the first protocol layer is a PDCP layer.

In one embodiment, the protocol layer other than the first protocol layer is an SDAP layer.

In one embodiment, the protocol layer other than the first protocol layer is an IP layer.

In one embodiment, the protocol layer other than the first protocol layer is a TNL layer.

In one embodiment, the protocol layer other than the first protocol layer is an RLC layer.

In one embodiment, the protocol layer other than the first protocol layer is a TCP, UDP or RTP layer.

In one embodiment, the protocol layer other than the first protocol layer is a Non-Access-Stratum (NAS).

In one embodiment, the protocol layer other than the first protocol layer is an application layer.

In one embodiment, the first operation is performed by the first protocol layer.

In one embodiment, the first operation is performed by a protocol entity of the first protocol layer.

In one embodiment, the first timer is a timer of the first protocol layer.

In one embodiment, the first timer comprises a discardTimer.

In one embodiment, the first timer comprises t-Reordering.

In one embodiment, the first timer comprises t-Reassembly.

In one embodiment, the action of starting a first timer includes starting and restarting the first timer.

In one embodiment, the name of the first timer in instances when the first operation is transmitting is the same as the name of the first timer in instances when the first operation is receiving.

In one embodiment, the name of the first timer in instances when the first operation is transmitting is different from the name of the first timer in instances when the first operation is receiving.

In one subembodiment, the name of the first timer includes timer.

In one embodiment, a serving cell of the first node configures an expiration value of the first timer.

In one embodiment, an expiration value of the first timer is sent via a broadcast message.

In one subembodiment, the broadcast message comprises a SIB.

In one embodiment, an expiration value of the first timer is sent via a unicast message.

In one subembodiment, the unicast message comprises an RRC message transmitted on a DCCH.

In one embodiment, the first timer is specific to the first data packet set.

In one embodiment, the first timer is associated with the first data packet set.

In one embodiment, the first data packet and the second data packet are different.

In one embodiment, the first data packet and the second data packet have different packet headers.

In one embodiment, the first data packet and the second data packet have different sequence numbers.

In one embodiment, the first data packet and the second data packet occupy different logical channels.

In one embodiment, the first data packet and the second data packet are processed by a same MAC entity.

In one embodiment, the first data packet and the second data packet are processed by different MAC entities.

In one embodiment, a condition for stopping the first timer comprises that feedback for the first data packet has been received.

In one embodiment, a condition for stopping the first timer comprises that the first data packet has been successfully sent or received.

In one embodiment, a condition for stopping the first timer comprises that a timer other than the first timer stops.

In one embodiment, a condition for stopping the first timer comprises that a timer other than the first timer expires.

In one embodiment, a condition for stopping the first timer comprises that a data packet in the first data packet set has been received.

In one embodiment, a condition for stopping the first timer comprises that a data packet in the first data packet set has been sent.

In one embodiment, a condition for stopping the first timer comprises that any data packet in the first data packet set has been sent.

In one embodiment, a condition for stopping the first timer comprises that any data packet in the first data packet set has been received.

In one embodiment, a condition for stopping the first timer comprises that the second data packet has been sent.

In one embodiment, a condition for stopping the first timer comprises that the second data packet has been received.

In one embodiment, a condition for stopping the first timer comprises that an RRCReconfiguration message has been received.

In one embodiment, a condition for stopping the first timer comprises that a Reconfiguration WithSync message has been received.

In one embodiment, a condition for stopping the first timer comprises that all data packets in the first data packet set have been sent.

In one embodiment, a condition for stopping the first timer comprises that all data packets in the first data packet set have been received.

In one embodiment, a condition for stopping the first timer comprises that cell re-selection has occurred.

In one embodiment, a condition for stopping the first timer comprises that path switch has occurred.

In one embodiment, a condition for stopping the first timer comprises that cell handover has occurred.

In one embodiment, a condition for stopping the first timer comprises that the second operation is performed at the first protocol layer for any data packet in the first data packet set before the first timer expires.

In one embodiment, a condition for stopping the first timer comprises that the second operation is performed at the first protocol layer for the second data packet before the first timer expires.

In one embodiment, a condition for stopping the first timer comprises that any data packet in the first data packet set is discarded before the first timer expires.

In one embodiment, a condition for stopping the first timer comprises that the second data packet is discarded at the first protocol layer before the first timer expires.

In one embodiment, a condition for stopping the first timer comprises that before the first timer expires, any data packet in the first data packet set is submitted to a protocol layer other than the first protocol layer.

In one embodiment, a condition for stopping the first timer comprises that before the first timer expires, the second data packet at the first protocol layer is submitted to a protocol layer other than the first protocol layer.

In one embodiment, an expiration of the first timer is not used to trigger a radio link failure.

In one embodiment, an expiration of the first timer is not used to trigger an RRC re-establishment.

In one embodiment, as a response to the expiration of the first timer, an indication is reported to an upper layer of the first protocol layer.

In one embodiment, as a response to the expiration of the first timer, an indication about failure is reported to an upper layer of the first protocol layer.

In one embodiment, as a response to the expiration of the first timer, an indication is reported to a protocol layer other than the first protocol layer.

In one embodiment, as a response to the expiration of the first timer, an indication about failure is reported to a protocol layer other than the first protocol layer.

In one embodiment, as a response to the expiration of the first timer, relevant information is recorded in a state variable.

In one embodiment, as a response to the expiration of the first timer, information about the failure is recorded in a state variable.

In one embodiment, as a response to the expiration of the first timer, measurement information is generated.

In one subembodiment, the measurement information comprises a higher layer measurement result.

In one subembodiment, the measurement information comprises a L2 measurement result.

In one embodiment, a report is sent as a response to the expiration of the first timer.

In one embodiment, a measurement report is sent as a response to the expiration of the first timer.

In one subembodiment, the measurement report comprises a higher layer measurement result.

In one subembodiment, the measurement report comprises a L2 measurement result.

In one embodiment, cell re-selection occurs at the first node.

In one subembodiment, the first node undergoes cell re-selection before the first timer starts.

In one subembodiment, the first node undergoes cell re-selection during the running of the first timer.

In one embodiment, relay re-selection or selection occurs at the first node.

In one subembodiment, the first node undergoes relay re-selection or selection before the first timer starts.

In one subembodiment, the first node undergoes relay re-selection or selection during the running of the first timer.

In one embodiment, the first node has undergone a switchover.

In one subembodiment, the first node undergoes the switchover before the first timer starts.

In one subembodiment, the first node undergoes the switchover during the running of the first timer.

In one embodiment, the first node has undergone a path switch.

In one subembodiment, the first node undergoes the path switch before the first timer starts.

In one subembodiment, the first node undergoes the path switch during the running of the first timer.

In one embodiment, the phrase submitting to a protocol layer other than the first protocol layer means: delivering to an upper layer of the first protocol layer.

In one embodiment, the phrase submitting to a protocol layer other than the first protocol layer means: delivering to a lower layer of the first protocol layer.

In one embodiment, the phrase submitting to a protocol layer other than the first protocol layer means: transmitting to an upper layer of the first protocol layer.

In one embodiment, the phrase submitting to a protocol layer other than the first protocol layer means: transmitting to a lower layer of the first protocol layer.

In one embodiment, the meaning of the phrase that the first data packet and the second data packet are different comprises that at least partial bits of the first data packet and the second data packet are different.

In one embodiment, the meaning of the phrase that the first data packet and the second data packet are different comprises that the first data packet and the second data packet have different sizes.

In one embodiment, the meaning of the phrase that the first data packet and the second data packet are different comprises that the first data packet and the second data packet have different sequence numbers.

In one embodiment, the meaning of the phrase that the first data packet and the second data packet are different comprises that the first data packet and the second data packet have different SDUs.

In one embodiment, the meaning of the phrase that the first data packet and the second data packet are different comprises that the first data packet and the second data packet are generated by different protocol entities.

In one embodiment, the meaning of the phrase the first data packet and the second data packet are different comprises that the first data packet and the second data packet have different protocol headers or subheaders.

In one embodiment, the meaning of the phrase the first data packet and the second data packet are different comprises that the first data packet and the second data packet are different in at least one field.

In one embodiment, the meaning of the sentence that the first data packet and any data packet in the first data packet set are data packets for a user plane is that the first data packet and any data packet in the first data packet set are user-plane PDUs.

In one embodiment, the meaning of the sentence that the first data packet and any data packet in the first data packet set are data packets for a user plane is that the first data packet and any data packet in the first data packet set are generated by a user-plane protocol layer.

In one embodiment, the meaning of the sentence that the first data packet and any data packet in the first data packet set are data packets for a user plane is that the first data packet and any data packet in the first data packet set are generated by a user-plane protocol entity.

In one embodiment, the meaning of the sentence that the first data packet and any data packet in the first data packet set are data packets for a user plane is that the first data packet and any data packet in the first data packet set include only user-plane data.

In one embodiment, the meaning of the sentence that the first data packet and any data packet in the first data packet set are data packets for a user plane is that neither the first data packet nor any data packet in the first data packet set includes control signaling.

In one embodiment, the meaning of the sentence that the first data packet and any data packet in the first data packet set are data packets for a user plane is that neither the first data packet nor any data packet in the first data packet set includes RRC signaling.

In one embodiment, the meaning of the sentence that the first data packet and any data packet in the first data packet set are data packets for a user plane is that neither the first data packet nor any data packet in the first data packet set is a control PDU.

In one embodiment, the meaning of the sentence that the first data packet and any data packet in the first data packet set are data packets for a user plane is that the first data packet and any data packet in the first data packet set both use a data radio bearer (DRB).

In one embodiment, the meaning of the sentence that the first data packet and any data packet in the first data packet set are both generated at the first protocol layer comprises that the first data packet and any data packet in the first data packet set are both PDUs at the first protocol layer.

In one embodiment, the meaning of the sentence that the first data packet and any data packet in the first data packet set are both generated at the first protocol layer comprises that the first data packet and any data packet in the first data packet set are both packetized at the first protocol layer.

In one embodiment, the meaning of the sentence that the first data packet and any data packet in the first data packet set are both generated at the first protocol layer comprises that SDUs included in the first data packet and any data packet in the first data packet set are encapsulated at the first protocol layer as PDUs of the first protocol layer.

In one embodiment, the meaning of the sentence that the first data packet and any data packet in the first data packet set are both generated at the first protocol layer comprises that SDUs of the first data packet and any data packet in the first data packet set are encapsulated and added to a protocol header at the first protocol layer.

In one embodiment, the meaning of the sentence that the first data packet and any data packet in the first data packet set are both generated at the first protocol layer comprises that all bits of the first data packet and any data packet in the first data packet set are generated at the first protocol layer.

In one embodiment, the meaning of the sentence that the first data packet and any data packet in the first data packet set are both generated at the first protocol layer comprises that at least headers of the first data packet and any data packet in the first data packet set are generated at the first protocol layer.

In one embodiment, the meaning of the sentence that at least part of bits of the first data packet are transmitted via a Data Radio Bearer (DRB) comprises that the first data packet is transmitted via a DRB.

In one subembodiment, the first data packet is a PDCP PDU.

In one embodiment, the meaning of the sentence that at least part of bits of the first data packet are transmitted via a Data Radio Bearer (DRB) comprises that the first data packet is mapped to a DRB.

In one subembodiment, the first data packet is a PDCP PDU.

In one subembodiment, the first data packet is an SDAP PDU.

In one subembodiment, the first data packet is a PDU above the SDAP layer.

In one embodiment, the meaning of the sentence that at least part of bits of the first data packet are transmitted via a Data Radio Bearer (DRB) comprises that when the first protocol layer is a PDCP layer or a layer above the PDCP layer, all of the bits of the first data packet are transmitted via a DRB: when the first protocol layer is an RLC layer, SDUs of the first data packet are transmitted via a DRB.

In one embodiment, the meaning of the sentence that at least part of bits of the first data packet are transmitted via a Data Radio Bearer (DRB) comprises that when the first protocol layer is a PDCP layer or a layer above the PDCP layer, all of the bits of the first data packet are transmitted via a DRB: when the first protocol layer is a protocol layer below the PDCP layer and above an RLC layer, SDUs of the first data packet are transmitted via a DRB.

In one embodiment, the meaning of the sentence that at least part of bits of the first data packet are transmitted via a Data Radio Bearer (DRB) comprises that the first data packet does not include RRC signaling.

In one embodiment, the meaning of the sentence that at least part of bits of the first data packet are transmitted via a Data Radio Bearer (DRB) comprises that the first data packet does not include control-plane signaling.

In one embodiment, the meaning of the sentence that at least part of bits of the first data packet are transmitted via a Data Radio Bearer (DRB) comprises that SDUs of the first data packet are transmitted via a DRB.

In one subembodiment, the first data packet is an RLC PDU.

In one subembodiment, the SDU of the first data packet is a PDCP PDU.

In one subembodiment, transmission resources occupied by the first data packet comprise a DRB.

In one subembodiment, transmission resources occupied by the first data packet are associated with the DRB.

In one subembodiment, the DRB is mapped to the transmission resources occupied by the first data packet.

In one subembodiment, all SDUs of the first data packet are transmitted via the DRB.

In one subembodiment, the first data packet does not include control-plane PDUs.

In one embodiment, a field of a packet header of the first data packet indicates that the first data packet is a data-type PDU.

In one subembodiment, the field of the packet header of the first data packet is a D/C field.

In one embodiment, one field of a packet header of any data packet in the first data packet set indicates that the type of the any data packet in the first data packet set is data.

In one subembodiment, the one field of the packet header of any data packet in the first data packet set is a D/C field.

In one embodiment, the first protocol layer is not an RRC layer.

In one embodiment, the first protocol layer is not a MAC layer.

In one embodiment, the user plane in the user-plane packet corresponds to the user plane in Embodiment 3.

In one embodiment, whether the first operation is receiving or transmitting is used to determine the second operation: when the first operation is receiving, the second operation is submitting to a second protocol layer: when the first operation is transmitting, the second operation is submitting to a third protocol layer or discarding.

In one subembodiment, the first protocol layer is an RLC layer and the second protocol layer is a PDCP layer.

In one subembodiment, the first protocol layer is a PDCP layer and the second protocol layer is an SDAP layer.

In one subembodiment, the first protocol layer is an SDAP layer and the second protocol layer is a NAS.

In one subembodiment, the first protocol layer is a NAS and the third protocol layer is an SDAP layer.

In one subembodiment, the first protocol layer is an SDAP layer and the third protocol layer is a PDCP layer.

In one subembodiment, the first protocol layer is a PDCP layer and the third protocol layer is an RLC layer.

In one subembodiment, the first protocol layer is an RLC layer and the third protocol layer is a MAC layer.

In one embodiment, when the first operation is transmitting, whether the second operation is submitting to the third protocol layer or discarding is related to the type of the second data packet.

In one subembodiment, when the second data packet is of a first type, the second operation is submitting to the third protocol layer, when the second data packet is of a second type, the second operation is discarding.

In one subembodiment, one of the first type and the second type is control and the other is data; one of the first type and the second type is retransmission and the other is not retransmission: one of the first type and the second type is segmentation and the other is not segmentation: one of the first type and the second type is high-priority and the other is low-priority: one of the first type and the second type is a packet carrying time information and the other is not a packet carrying time information: one of the first type and the second type is an end marker and the other is not an end marker.

In one embodiment, when the first operation is transmitting, whether the second operation is submitting to the third protocol layer or discarding is related to whether the second data packet includes a target identifier.

In one subembodiment, when the second data packet includes the target identifier, the second operation is submitting to the third protocol layer: when the second data packet does not include the target identifier, the second operation is discarding.

In one subembodiment, when the second data packet does not include the target identifier, the second operation is submitting to the third protocol layer: when the second data packet includes the target identifier, the second operation is discarding.

In one subembodiment, the target identifier is a field in a packet header of the second data packet.

In one subembodiment, the target identifier is an end marker.

In one subembodiment, the target identifier is a continue marker.

In one subembodiment, the target identifier is a discard marker.

In one subembodiment, the target identifier is a user-defined marker.

In one subembodiment, the target identifier is a user-recommended marker.

In one subembodiment, the target identifier is a marker submitted to the third protocol layer.

In one embodiment, when the first operation is transmitting, whether the second operation is submitting to the third protocol layer or discarding is related to QoS information of the second data packet.

In one subembodiment, when the QoS information of the second data packet indicates that the second data packet is a high-priority packet, the second operation is submitting to the third protocol layer: when the QoS information of the second data packet does not indicate that the second data packet is a high-priority packet, the second operation is discarding.

In one subembodiment, when the QOS information of the second data packet does not indicate that the second data packet is a high-priority packet, the second operation is submitting to the third protocol layer: when the QoS information of the second data packet indicates that the second data packet is a high-priority packet, the second operation is discarding.

In one subembodiment, when the QOS information of the second data packet indicates that the latency of the second data packet cannot be met, the second operation is discarding.

In one subembodiment, when the QoS information of the second data packet indicates that the latency of the second data packet cannot be met, the second operation is submitting to the third protocol layer.

In one embodiment, when the first operation is transmitting, whether the second operation is submitting to the third protocol layer or discarding is related to the relationship of mutual dependency between the second data packet and the first data packet.

In one subembodiment, when the second data packet depends on the first data packet, the second operation is submitting to the third protocol layer: when the second data packet does not depend on the first data packet, the second operation is discarding.

In one subembodiment, when the second data packet does not depend on the first data packet, the second operation is submitting to the third protocol layer: when the second data packet depends on the first data packet, the second operation is discarding.

In one subembodiment, when the first data packet depends on the second data packet, the second operation is submitting to the third protocol layer: when the first data packet does not depend on the second data packet, the second operation is discarding.

In one subembodiment, when the first data packet does not depend on the second data packet, the second operation is submitting to the third protocol layer: when the first data packet depends on the second data packet, the second operation is discarding.

In one embodiment, when the first operation is transmitting, whether the second operation is submitting to the third protocol layer or discarding is related to a bearer used by the first data packet.

In one subembodiment, the bearer used by the first data packet includes an RLC bearer.

In one subembodiment, the bearer used by the first data packet includes a sidelink bearer.

In one embodiment, when the first operation is transmitting, whether the second operation is submitting to the third protocol layer or discarding is related to a bearer used by the second data packet.

In one embodiment, when the first operation is transmitting, whether the second operation is submitting to the third protocol layer or discarding is related to the type of the first data packet.

In one embodiment, when the first operation is transmitting, whether the second operation is submitting to the third protocol layer or discarding is related to whether the first data packet includes a first identifier.

In one subembodiment, the first data packet includes the first identifier, and the second operation is submitting to the third protocol layer: the first data packet does not include the first identifier, and the second operation is discarding.

In one subembodiment, the first data packet does not include the first identifier, and the second operation is submitting to the third protocol layer: the first data packet includes the first identifier, and the second operation is discarding.

In one embodiment, when the first operation is transmitting, whether the second operation is submitting to the third protocol layer or discarding is related to whether the second data packet includes a first identifier.

In one subembodiment, the second data packet includes the first identifier, and the second operation is submitting to the third protocol layer: the second data packet does not include the first identifier, and the second operation is discarding.

In one subembodiment, the second data packet does not include the first identifier, and the second operation is submitting to the third protocol layer; the second data packet includes the first identifier, and the second operation is discarding.

In one embodiment, the first data packet and the second data packet use different Data Radio Bearers (DRBs).

In one subembodiment, the DRBs respectively used by the first data packet and the second data packet have an association relationship.

In one subembodiment, the DRBs respectively used by the first data packet and the second data packet have different identities.

In one subembodiment, one of the DRBs used by the first data packet and the second data packet is a DRB of an MCG and the other is a DRB of an SCG.

In one subembodiment, one of the DRBs used by the first data packet and the second data packet does not use relaying and the other uses relaying.

In one subembodiment, the DRBs used by the first data packet and the second data packet are both DRBs of the MCG.

In one subembodiment, the DRBs used by the first data packet and the second data packet are both split DRBs.

In one subembodiment, the meaning of the sentence that the first data packet and the second data packet use different DRBs comprises that the DRBs used by respective SDUs of the first data packet and the second data packet are different.

In one embodiment, the first data packet and the second data packet use a same DRB.

In one embodiment, the first data packet and the second data packet are associated with a same QoS flow.

In one embodiment, the first data packet and the second data packet are associated with different QoS flows.

In one embodiment, the first data packet includes a first identifier: a target data packet is any data packet in the first data packet set, and whether the target data packet includes the first identifier is used to determine whether to perform the second operation for the target data packet: when the target data packet includes the first identifier, the second operation is performed for the target data packet: when the target data packet does not include the first identifier, the second operation is not performed for the target data packet.

In one subembodiment, the second data packet includes the first identifier.

In one subembodiment, the first identifier is used to identify a set of PDUs.

In one subembodiment, the first identifier is used to identify the first data packet set.

In one embodiment, a target data packet is any data packet in the first data packet set, and whether the target data packet includes a second identifier is used to determine whether the second operation is submitting to a protocol layer other than the first protocol layer or discarding.

In one embodiment, the first data packet includes a first identifier; and any data packet in the first data packet set includes the first identifier: a target data packet is any data packet in the first data packet set, and whether the target data packet includes a second identifier is used to determine whether to perform the second operation for the target data packet: when the target data packet includes the second identifier, the second operation is performed for the target data packet: when the target data packet does not include the second identifier, the second operation is not performed for the target data packet.

In one embodiment, the time of expiration of the first timer is related to either the time of transmission of the second data packet or the time of arrival of a SDU of the second data packet.

In one subembodiment, the time of expiration of the first timer is related to the time of transmission of the second data packet.

In one subembodiment, the time of expiration of the first timer is related to the time of arrival of a SDU of the second data packet.

In one subembodiment, the first node forwards an SDU of the second data packet, and the time of expiration of the first timer is equal to a specific period of time after the time of arrival of a SDU included by the second data packet.

In one subembodiment, the first protocol layer generates the first data packet based on the SDU of the second data packet, and the time of expiration of the first timer is equal to a specific period of time after the time of arrival of a SDU included by the second data packet.

In one subembodiment, the second data packet includes only one SDU.

In one subembodiment, the SDU included by the second data packet is a latest one of the SDUs included in the second data packet that arrives.

In one subembodiment, the SDU included by the second data packet is an earliest one of the SDUs included in the second data packet that arrives.

In one subembodiment, the time of expiration of the first timer is equal to a specific period of time after the time of transmission of the second data packet.

In one subembodiment, the second data packet includes only one SDU.

In one embodiment, the time of expiration of the first timer is related to the time of buffering of the second data packet.

In one embodiment, the first data packet set includes a finite number of packets.

In one embodiment, any data packet in the first data packet set belongs to the same service.

In one embodiment, any data packet in the first data packet set belongs to the same PDU session.

In one embodiment, the first node generates all bits in all data packets included in the first data packet set.

In one embodiment, the first node forwards bits generated by other nodes via the first data packet.

In one embodiment, the first node forwards bits generated by other nodes via the second data packet.

In one embodiment, at least partial bits in any data packet in the first data packet set are generated by an XR server.

In one embodiment, at least partial bits in any data packet in the first data packet set are generated by an Edge server.

In one embodiment, at least partial bits in any data packet in the first data packet set are generated by a core network device.

In one embodiment, at least partial bits in any data packet in the first data packet set are generated by an access network device.

In one embodiment, the second data packet is a PDU.

In one embodiment, the second data packet is a PDCP PDU.

In one embodiment, the second data packet is an RLC PDU.

In one embodiment, the second data packet is an SDAP PDU.

In one embodiment, the second data packet is an IP PDU.

In one embodiment, any data packet in the first data packet set is generated by a PDCP layer.

In one embodiment, any data packet in the first data packet set is generated by an SDAP layer.

In one embodiment, any data packet in the first data packet set is generated by an IP layer.

In one embodiment, any data packet in the first data packet set is generated by a transmission layer.

In one embodiment, any data packet in the first data packet set is generated by an application layer.

In one embodiment, any data packet in the first data packet set is generated by a transmission network layer.

In one embodiment, any data packet in the first data packet set is generated by a network layer.

### Embodiment 2

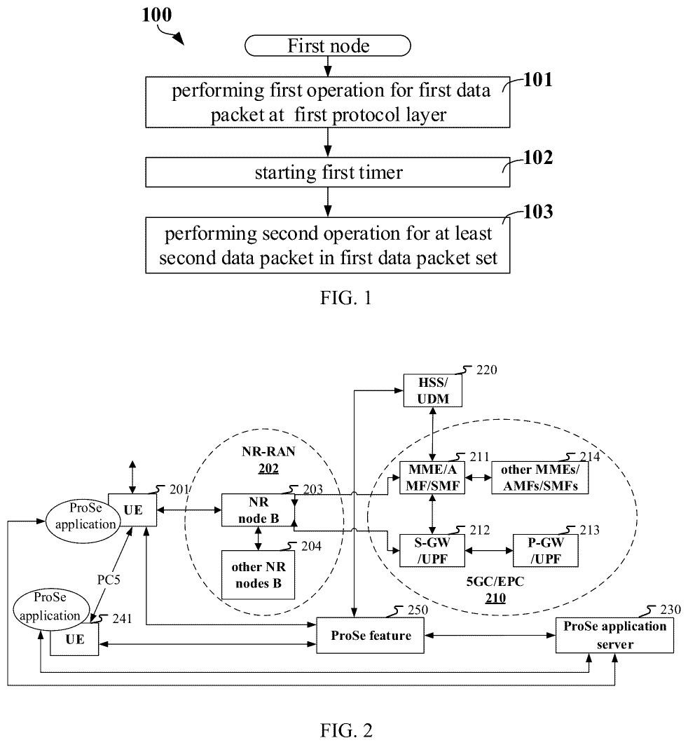

Embodiment 2 illustrates a schematic diagram of a network architecture according to the present application, as shown in FIG. 2.

FIG. 2 is a diagram illustrating a network architecture 200 of 5G NR, Long-Term Evolution (LTE) and Long-Term Evolution Advanced (LTE-A) systems. The 5G NR or LTE network architecture 200 may be called a 5G System/Evolved Packet System (5GS/EPS) 200 or other suitable terminology. The 5GS/EPS 200 may comprise one or more UEs 201, an NG-RAN 202, a 5G-Core Network/Evolved Packet Core (5GC/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services or other cellular networks. The NG-RAN 202 comprises an NR node B (gNB) 203 and other gNBs 204. The gNB 203 provides UE 201 oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an SI/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213.

The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the first node in the present application is the UE 201.

In one embodiment, a base station of the first node in the present application is the gNB203.

In one embodiment, a radio link from the UE 201 to the NR Node B is an uplink.

In one embodiment, a radio link from the NR Node B to the UE 201 is a downlink.

In one embodiment, the UE 201 supports relay transmission.

In one embodiment, the UE 201 includes cellphone.

In one embodiment, the UE 201 is a means of transportation including automobile.

In one embodiment, the UE 201 supports sidelink transmission.

In one embodiment, the UE 201 supports MBS transmission.

In one embodiment, the UE 201 supports MBMS transmission.

In one embodiment, the gNB 203 is a MacroCellular base station.

In one embodiment, the gNB203 is a Micro Cell base station.

In one embodiment, the gNB 203 is a PicoCell base station.

In one embodiment, the gNB203 is a flight platform.

In one embodiment, the gNB203 is satellite equipment.

### Embodiment 3

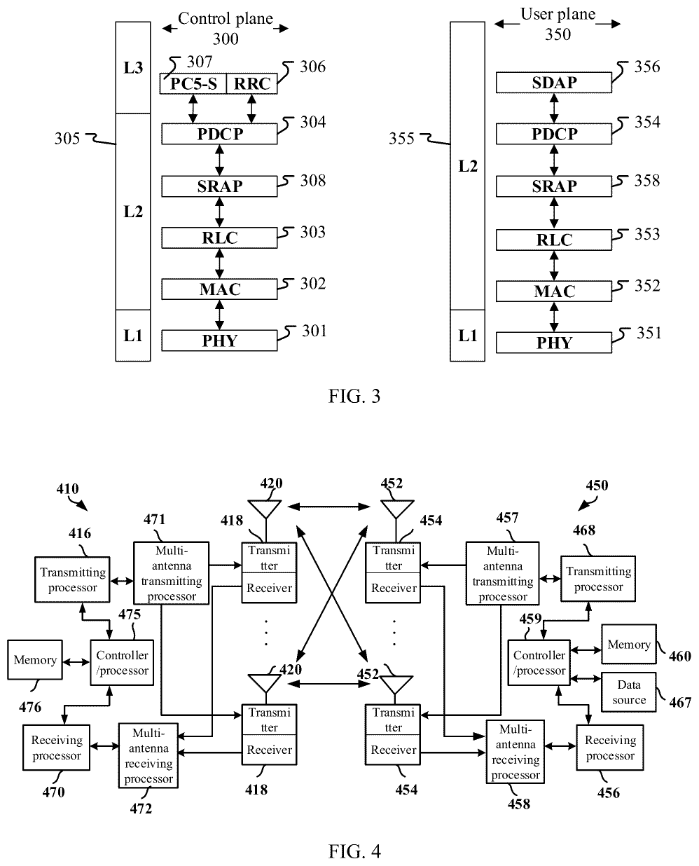

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first node (UE, gNB or, satellite or aircraft in NTN) and a second node (gNB, UE, or satellite or aircraft in NTN), or between two UEs, is represented by three layers, which are: layer 1, layer 2 and layer 3. The layer 1 (L1) is the lowest layer which performs signal processing functions of various PHY layers. The L1 is called PHY 301 in the present application. The layer 2 (L2) 305 is above the PHY 301, and is in charge of the link between a first node and a second node as well as between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second nodes. The PDCP sublayer 304 provides multiplexing among variable radio bearers and logical channels. The PDCP sublayer 304 provides security by encrypting packets and also support for inter-cell handover of the first node between second nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first nodes various radio resources (i.e., resource block) in a cell. The MAC sublayer 302 is also in charge of HARQ operation. In the control plane 300, the RRC sublayer 306 in the L3 layer is responsible for acquiring radio resources (i.e., radio bearer) and configuring the lower layer using an RRC signaling between the second node and the first node. The PC5 Signaling (PC5-S) Protocol sublayer 307 is responsible for the signaling protocol processing of the PC5 interface. The radio protocol architecture in the user plane 350 comprises the L1 layer and the L2 layer. In the user plane 350, the radio protocol architecture used for the first node and the second node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. SRBs can be viewed as services or interfaces provided by the PDCP layer to higher layers, such as the RRC layer. In NR systems SRBs include SRB1, SRB2, SRB3, and SRB4 when sidelink communications is involved, which are respectively used to transmit different types of control signaling. The SRB is a bearer between the UE and an access network and is used to transmit control signalings, including RRC signaling, between the UE and the access network. SRB1 has special significance for UEs. After each UE establishes an RRC connection, it will have a SRB1 for transmitting RRC signaling, and most of the signalings are transmitted through SRB1. If SRB1 is interrupted or unavailable, the UE has to carry out RRC re-establishment. SRB2 is generally only used to transmit NAS signaling or signaling related to security. The UE does not have to configure SRB3. Unless for urgent traffics, the UE must establish an RRC connection with the network to proceed with communications. Although not described in FIG. 3, the first node may comprise several higher layers above the L2 355. Besides, the first node comprises a network layer (i.e., IP layer) terminated at a P-GW 213 of the network side and an application layer terminated at the other side of the connection (i.e., a peer UE, a server, etc.). For a UE involving relay services, its control plane can also comprise a PC5-S307 and an

Adaptation sublayer Sidelink Relay Adaptation Protocol (SRAP) 308, and its user plane can also comprise an Adaptation sublayer SRAP358. The introduction of the Adaptation layer is beneficial to lower layers, for instance, a MAC layer, or an RLC layer, to multiplex and/or distinguish data from multiple source UEs. For nodes not joined in relay communications, none of the PC5-S307, SRAP308 and SRAP358 will be needed in the process of communications.

The user plane in this application is the user plane 350 in FIG. 3 attached.

In one embodiment, the radio protocol architecture in FIG. 3 is applicable to the first node in the present application.

In one embodiment, any data packet in the first data packet set of this application is generated at a protocol layer above the RLC353, SRAP358, PDCP354 or SDAP356 or SDAP356.

In one embodiment, the first data packet of this application is generated at a protocol layer above the RLC353, SRAP358, PDCP354 or SDAP356 or SDAP356.

In one embodiment, the second data packet of this application is generated at a protocol layer above the RLC353, SRAP358, PDCP354 or SDAP356 or SDAP356.

In one embodiment, the first information in the present application is generated by the MAC302 or RRC306 or NAS.

In one embodiment, the second information in the present application is generated by the MAC302 or RRC306 or NAS.

In one embodiment, the third information in the present application is generated by the MAC302 or RRC306 or NAS.

### Embodiment 4

Embodiment 4 illustrates a schematic diagram of a first communication device and a second communication device according to one embodiment of the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, and optionally a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, and optionally a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer (Layer-2). In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of a retransmission of a lost packet and a signaling to the first communication device 450. The transmitting processor 416 and the multi-antenna transmitting processor 471 perform various signal processing functions used for the

L1 layer (i.e., PHY). The transmitting processor 416 performs coding and interleaving so as to ensure a Forward Error Correction (FEC) at the second communication device 410 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams.

Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450-targeted spatial stream. Symbols on each spatial stream are demodulated and recovered in the receiving processor 456 to generate a soft decision.

Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with the memory 460 that stores program code and data: the memory 460 may be called a computer readable medium. In the transmission from the second communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data: the memory 476 may be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory. The at least one memory comprises computer program codes: the at least one memory and the computer program codes are configured to be used in collaboration with the at least one processor. The first communication device 450 at least performs a first operation for a first data packet at a first protocol layer, the first operation being receiving, or the first operation being transmitting: as a response to the action of performing the first operation, starts a first timer, and as a response to expiration of the first timer, performs a second operation for at least second data packet in a first data packet set at the first protocol layer: the second operation being submitting to a protocol layer other than the first protocol layer, or the second operation being discarding: herein, the first data packet is different from the second data packet: the first data packet and any data packet in the first data packet set are data packets for a user plane; and the first data packet and any data packet in the first data packet set are both generated at the first protocol layer: the first protocol layer is a protocol layer above a Media Access Control (MAC) layer: at least part of bits of the first data packet are transmitted via a Data Radio Bearer (DRB).

In one embodiment, the first communication device 450 comprises a memory that stores a computer readable instruction program. The computer readable instruction program generates actions when executed by at least one processor. The actions include: performing a first operation for a first data packet at a first protocol layer, the first operation being receiving, or the first operation being transmitting: as a response to the action of performing the first operation, starting a first timer, and as a response to expiration of the first timer, performing a second operation for at least second data packet in a first data packet set at the first protocol layer: the second operation being submitting to a protocol layer other than the first protocol layer, or the second operation being discarding: herein, the first data packet is different from the second data packet: the first data packet and any data packet in the first data packet set are data packets for a user plane; and the first data packet and any data packet in the first data packet set are both generated at the first protocol layer: the first protocol layer is a protocol layer above a Media Access Control (MAC) layer: at least part of bits of the first data packet are transmitted via a Data Radio Bearer (DRB).

In one embodiment, the first communication device 450 corresponds to the first node in the present application.

In one embodiment, the first communication device 450 is a UE.

In one embodiment, the first communication device 450 is a vehicle-mounted terminal.

In one embodiment, the first communication device 450 is a base station.

In one embodiment, the receiver 454 (comprising the antenna 452), the receiving processor 456 and the controller/processor 459 are used for receiving the first information in the present application.

In one embodiment, the receiver 454 (comprising the antenna 452), the receiving processor 456 and the controller/processor 459 are used for receiving the third information in the present application.

In one embodiment, the receiver 454 (comprising the antenna 452), the receiving processor 456 and

the controller/processor 459 are used for receiving the first data packet in the present application.

In one embodiment, the transmitter 454 (comprising the antenna 452), the transmitting processor 468 and the controller/processor 459 are used for transmitting the first data packet in the present application.

In one embodiment, the transmitter 454 (comprising the antenna 452), the transmitting processor 468 and the controller/processor 459 are used for transmitting the second information in the present application.

### Embodiment 5

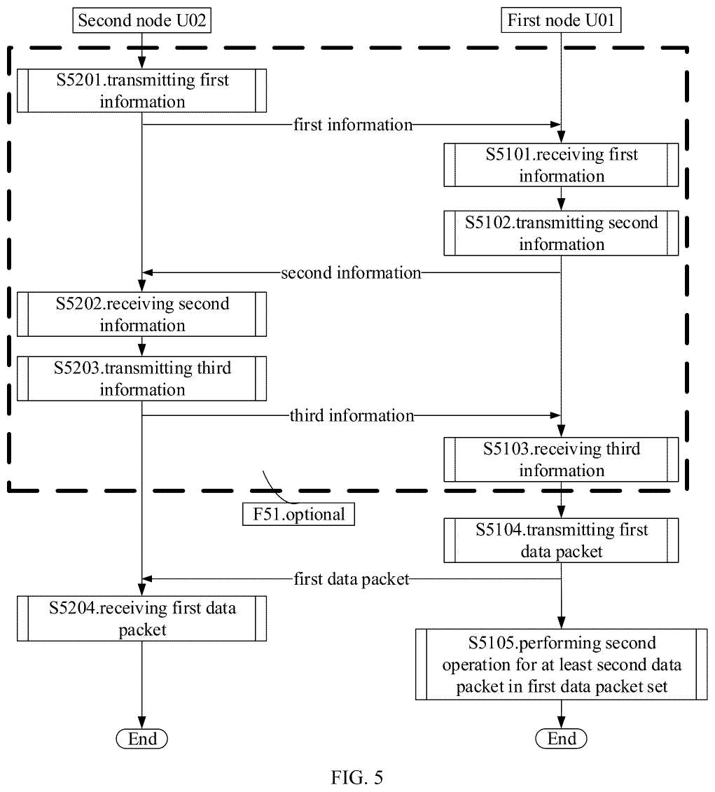

Embodiment 5 illustrates a flowchart of radio signal transmission according to one embodiment of the present application, as shown in FIG. 5. In FIG. 5, U01 corresponds to the first node in the present application. It should be particularly noted that the sequence illustrated herein does not set any limit on the orders in which signals are transmitted and implementations in this present application. Steps here in F51 are optional.

The first node U01 receives first information in step S5101: transmits second information in step S5102: receives third information in step S5103: transmits a first data packet in step S5104; and performs a second operation for at least second data packet in a first data packet set in step S5105.

The second node U02 transmits first information in step S5201: receives second information in step S5202: transmits third information in step S5203; and receives a first data packet in step S5204.

In Embodiment 5, the first node U01 performs a first operation for a first data packet at a first protocol layer, the first operation being transmitting: as a response to the action of performing the first operation, starts a first timer, and as a response to expiration of the first timer, performs a second operation for at least second data packet in a first data packet set at the first protocol layer: the second operation being submitting to a protocol layer other than the first protocol layer, or the second operation being discarding:

herein, the first data packet is different from the second data packet: the first data packet and any data packet in the first data packet set are data packets for a user plane; and the first data packet and any data packet in the first data packet set are both generated at the first protocol layer: the first protocol layer is a protocol layer above a Media Access Control (MAC) layer: at least part of bits of the first data packet are transmitted via a Data Radio Bearer (DRB).

In one embodiment, the first node U01 is a UE, and the second node U02 is a serving cell or a cell group of the first node U01.

In one subembodiment, the first data packet is transmitted using uplink resources or an uplink.

In one embodiment, the first node U01 is a UE, and the second node U02 is a base station serving the first node U01.

In one subembodiment, the first data packet is transmitted using uplink resources or an uplink.

In one embodiment, the first data packet is transmitted via the sidelink.

In one embodiment, the first node U01 and the second node U02 are both UEs.

In one embodiment, the first node U01 is a node in RAN.

In one embodiment, the second node U02 is a UE.

In one embodiment, the first node U01 transmits the first data packet via an uplink.

In one embodiment, the first information is used to indicate data packet(s) included in the first data packet set.

In one embodiment, the first information is a control signaling.

In one embodiment, the first information is an RRC signaling.

In one embodiment, the first information is Non-Access-Stratum (NAS) information.

In one embodiment, the first information and the first data packet are transmitted together.

In one embodiment, the first information is a protocol header of the first data packet.

In one embodiment, any data packet in the first data packet set comprises a copy of the first information.

In one embodiment, the first information indicates an identity of the first data packet set.

In one embodiment, the first information indicates an index of the first data packet set.

In one embodiment, the first information indicates an identifier of the first data packet set, and each packet carrying the identifier belongs to the first data packet set.

In one embodiment, the first information comprises a MAC control element (CE).

In one embodiment, the first information comprises a header or sub-header of a MAC protocol data

unit (PDU).

In one embodiment, the first information comprises downlink control information (DCI).

In one embodiment, the first information comprises sidelink control information (SCI).

In one embodiment, the first data packet comprises the first information.

In one embodiment, the first information indicates dedicated transmission resources occupied by the first data packet set, where the first data packet uses the dedicated transmission resources of the first data packet set.

In one embodiment, the first information indicates characteristic parameters of the first data packet set, the first data packet carrying the characteristic parameters of the first data packet set.

In one embodiment, the first information indicates the number of data packets included in the first data packet set.

In one embodiment, the first information indicates one offset, and the number of data packets included in the first data packet set is a sum of a pre-configured value and the offset indicated by the first information.

In one embodiment, the first information indicates one offset, and the number of data packets included in the first data packet set is a sum of a higher-layer configured value and the offset indicated by the first information.

In one embodiment, the first information indicates one offset, and the number of data packets included in the first data packet set is a sum of a default value and the offset indicated by the first information.

In one embodiment, the second information comprises Non-Access-Stratum (NAS) information.

In one embodiment, the second information comprises an RRC message.

In one embodiment, the second information comprises a MAC CE.

In one embodiment, the second information comprises SCI.

In one embodiment, the second information comprises UEAssistanceInformation.

In one embodiment, the second information indicates the number of data packets included in the first data packet set.

In one embodiment, the second information indicates one offset, and the number of data packets included in the first data packet set is a sum of a pre-configured value and the offset indicated by the second information.

In one embodiment, the second information indicates one offset, and the number of data packets included in the first data packet set is a sum of a higher-layer configured value and the offset indicated by the second information.

In one embodiment, the second information indicates one offset, and the number of data packets included in the first data packet set is a sum of a default value and the offset indicated by the second information.

In one embodiment, the second information indicates an identity of the first data packet set.

In one embodiment, the second information indicates an index of the first data packet set.

In one embodiment, the second information indicates an identifier of the first data packet set, and each packet carrying the identifier belongs to the first data packet set.

In one embodiment, the third information indicates a first radio bearer set, the first radio bearer set including at least one radio bearer.

In one embodiment, the third information is an RRC message.

In one embodiment, the third information is a NAS message.

In one embodiment, the third information is a PC5-S message.

In one embodiment, radio bearers included in the first radio bearer set are all DRBs.

In one embodiment, radio bearers included in the first radio bearer set are all SLRBs.

In one embodiment, radio bearers included in the first radio bearer set are all sidelink DRBs.

In one embodiment, radio bearers included in the first radio bearer set are all MCG DRBs.

In one embodiment, radio bearers included in the first radio bearer set include a DRB of an MCG and

a DRB of an SCG.

In one embodiment, the third information indicates an identity of any radio bearer in the first radio bearer set.

In one embodiment, the third information indicates an index of any radio bearer in the first radio bearer set.

In one embodiment, the step S5102 is earlier than the step S5101.

In one embodiment, the step S5102 and the step S5101 do not occur simultaneously.

In one embodiment, the step S5102 and the step S5101 may occur simultaneously:

In one embodiment, the step S5102 and the step S5201 do not occur simultaneously:

In one embodiment, the step S5102 and the step S5201 may occur simultaneously.

In one embodiment, the second node U02 has received the first data packet in step S5204.

In one embodiment, the second node U02 does not correctly decode the first data packet in step S5204.

In one embodiment, the first node U01 receives an acknowledgment for the first data packet after step S5104.

In one embodiment, the first node U01 has not received an acknowledgment for the first data packet after step S5104.

In one embodiment, the first node U01 performs the second operation for any data packet in the first data packet set.

In one embodiment, the first node U01 submits any data packet in the first data packet set to a protocol layer other than the first protocol layer.

In one embodiment, the first node U01 discards any data packet in the first data packet set.

In one embodiment, the first node U01 performs the second operation only for the second data packet and does not perform the second operation for any data packet other than the second data packet in the first data packet set.

In one embodiment, the first node U01 submits part of packets in the first data packet set to a protocol layer other than the first protocol layer: the first node discards part of the packets in the first data packet set. In one embodiment, the step S5105 is after the step S5104.

In one embodiment, as a response to performing the second operation, the first node U01 logs and

reports to the network the packets in the first data packet set on which the second operation has been performed.

### Embodiment 6

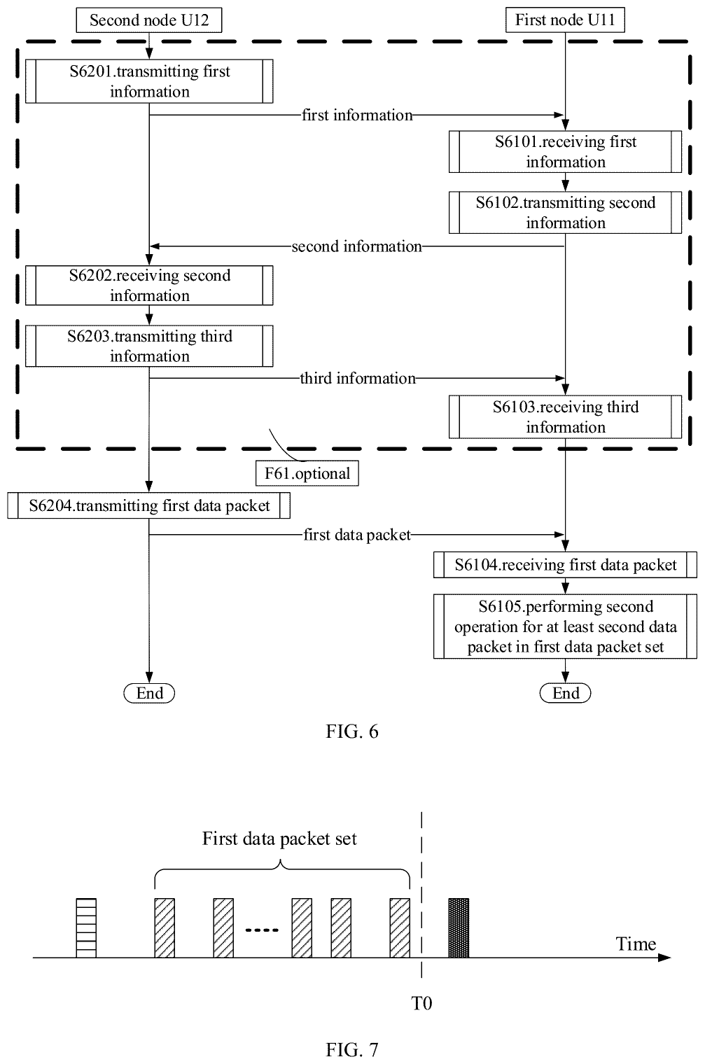

Embodiment 6 illustrates a flowchart of radio signal transmission according to one embodiment of the present application, as shown in FIG. 6. In FIG. 6, U11 corresponds to the first node in the present application. It should be particularly noted that the sequence illustrated herein does not set any limit on the orders in which signals are transmitted and implementations in this present application. Steps here in F61 are optional.

The first node U11 receives first information in step S6101: transmits second information in step S6102: receives third information in step S6103: receives a first data packet in step S6104; and performs a second operation for at least second data packet in a first data packet set in step S6105.

The second node U12 transmits first information in step S6201: receives second information in step S6202: transmits third information in step S6203; and transmits a first data packet in step S6204.

In Embodiment 6, the first node U11 performs a first operation for a first data packet at a first protocol layer, the first operation being receiving: as a response to the action of performing the first operation, starts a first timer, and as a response to expiration of the first timer, performs a second operation for at least second data packet in a first data packet set at the first protocol layer: the second operation being submitting to a protocol layer other than the first protocol layer, or the second operation being discarding:

herein, the first data packet is different from the second data packet: the first data packet and any data packet in the first data packet set are data packets for a user plane; and the first data packet and any data packet in the first data packet set are both generated at the first protocol layer: the first protocol layer is a protocol layer above a Media Access Control (MAC) layer: at least part of bits of the first data packet are transmitted via a

### Data Radio Bearer (DRB).

In one embodiment, the first node U11 is a UE, and the second node U12 is a serving cell or a cell group of the first node U11.

In one subembodiment, the first data packet is transmitted using downlink resources or a downlink.

In one embodiment, the first data packet is transmitted via the sidelink.

In one embodiment, the first node U11 is a UE, and the second node U12 is a base station serving the first node U11.

In one subembodiment, the first data packet is transmitted using downlink resources or a downlink.

In one embodiment, the first node U11 and the second node U12 are both UEs.

In one embodiment, the first node U11 is a node in RAN.

In one embodiment, the second node U12 is a UE.

In one embodiment, the first node U11 transmits the first data packet via an uplink.

In one embodiment, the first information is used to indicate data packet(s) included in the first data packet set.

In one embodiment, the first information is a control signaling.

In one embodiment, the first information is an RRC signaling.

In one embodiment, the first information is Non-Access-Stratum (NAS) information.

In one embodiment, the first information and the first data packet are transmitted together.

In one embodiment, the first information is a protocol header of the first data packet.

In one embodiment, any data packet in the first data packet set comprises a copy of the first information.

In one embodiment, the first information indicates an identity of the first data packet set.

In one embodiment, the first information indicates an index of the first data packet set.

In one embodiment, the first information indicates an identifier of the first data packet set, and each packet carrying the identifier belongs to the first data packet set.

In one embodiment, the first information comprises a MAC control element (CE).

In one embodiment, the first information comprises a header or sub-header of a MAC protocol data unit (PDU).

In one embodiment, the first information comprises downlink control information (DCI).

In one embodiment, the first information comprises sidelink control information (SCI).

In one embodiment, the first data packet comprises the first information.

In one embodiment, the first information indicates dedicated transmission resources occupied by the first data packet set, where the first data packet uses the dedicated transmission resources of the first data packet set.

In one embodiment, the first information indicates characteristic parameters of the first data packet set, the first data packet carrying the characteristic parameters of the first data packet set.

In one embodiment, the first information indicates the number of data packets included in the first data packet set.

In one embodiment, the first information indicates one offset, and the number of data packets included in the first data packet set is a sum of a pre-configured value and the offset indicated by the first information. In one embodiment, the first information indicates one offset, and the number of data packets included

in the first data packet set is a sum of a higher-layer configured value and the offset indicated by the first information.

In one embodiment, the first information indicates one offset, and the number of data packets included in the first data packet set is a sum of a default value and the offset indicated by the first information.

In one embodiment, the second information comprises Non-Access-Stratum (NAS) information.

In one embodiment, the second information comprises an RRC message.

In one embodiment, the second information comprises a MAC CE.

In one embodiment, the second information comprises SCI.

In one embodiment, the second information comprises UEAssistanceInformation.

In one embodiment, the second information indicates the number of data packets included in the first data packet set.

In one embodiment, the second information indicates one offset, and the number of data packets included in the first data packet set is a sum of a pre-configured value and the offset indicated by the second information.

In one embodiment, the second information indicates one offset, and the number of data packets included in the first data packet set is a sum of a higher-layer configured value and the offset indicated by the second information.

In one embodiment, the second information indicates one offset, and the number of data packets included in the first data packet set is a sum of a default value and the offset indicated by the second information.

In one embodiment, the second information indicates an identity of the first data packet set.

In one embodiment, the second information indicates an index of the first data packet set.

In one embodiment, the second information indicates an identifier of the first data packet set, and each packet carrying the identifier belongs to the first data packet set.

In one embodiment, the third information indicates a first radio bearer set, the first radio bearer set including at least one radio bearer.

In one embodiment, the third information is an RRC message.

In one embodiment, the third information is a NAS message.

In one embodiment, the third information is a PC5-S message.

In one embodiment, radio bearers included in the first radio bearer set are all DRBs.

In one embodiment, radio bearers included in the first radio bearer set are all SLRBs.

In one embodiment, the first radio bearer set includes an MRB.

In one embodiment, radio bearers included in the first radio bearer set are all sidelink DRBs.

In one embodiment, radio bearers included in the first radio bearer set are all MCG DRBs.

In one embodiment, radio bearers included in the first radio bearer set include a DRB of an MCG and a DRB of an SCG.

In one embodiment, the first data packet is transmitted using a PTP branch of the MRB.

In one embodiment, the first data packet is transmitted using a PTM branch of the MRB.

In one embodiment, the second data packet is transmitted using a PTP branch of the MRB.

In one embodiment, the second data packet is transmitted using a PTM branch of the MRB.

In one embodiment, a C-RNTI is used to schedule the first data packet: a G-RNTI is used to schedule

the second data packet.

In one embodiment, a G-RNTI is used to schedule the first data packet; a C-RNTI is used to schedule the second data packet.

In one embodiment, a C-RNTI is used to transmit the first data packet: a G-RNTI is used to transmit the second data packet.

In one embodiment, a G-RNTI is used to transmit the first data packet: a C-RNTI is used to transmit the second data packet.

In one embodiment, the third information indicates an identity of any radio bearer in the first radio bearer set.

In one embodiment, the third information indicates an index of any radio bearer in the first radio bearer set.

In one embodiment, the step S6102 is earlier than the step S6101.

In one embodiment, the step S6102 and the step S6101 do not occur simultaneously.

In one embodiment, the step S6102 and the step S6101 may occur simultaneously.

In one embodiment, the step S6102 and the step S6201 do not occur simultaneously:

In one embodiment, the step S6102 and the step S6201 may occur simultaneously.

In one embodiment, the first node U11 has received the first data packet in step S6104.

In one embodiment, the first node U11 does not correctly decode the first data packet in step S6104.

In one embodiment, the first node U11 does not transmit an acknowledgement for the first data packet after step S6104.

In one embodiment, the first node U11 transmits an acknowledgment for the first data packet after step S6104.

In one embodiment, the first node U11 performs the second operation for any data packet in the first data packet set.

In one embodiment, the first node U11 submits any data packet in the first data packet set to a protocol layer other than the first protocol layer.

In one embodiment, the first node U11 discards any data packet in the first data packet set.

In one embodiment, the first node U11 performs the second operation only for the second data packet and does not perform the second operation for any data packet other than the second data packet in the first data packet set.

In one embodiment, the first node U11 submits part of packets in the first data packet set to a protocol layer other than the first protocol layer: the first node discards part of the packets in the first data packet set. In one embodiment, the step S6105 is after the step S6104.

In one embodiment, as a response to performing the second operation, the first node U11 logs and reports to the network the packets in the first data packet set on which the second operation has been performed.

### Embodiment 7

Embodiment 7 illustrates a schematic diagram of a first data packet set according to one embodiment of the present application, as shown in FIG. 7.

In one embodiment, the first data packet set includes at least two data packets.

In one embodiment, the first data packet set includes a finite number of packets.

In one embodiment, the first data packet set includes only the first data packet and the second data packet.

In one embodiment, the first data packet set includes the first data packet and the second data packet as well as other data packets.

In one embodiment, the number of data packet(s) included in the first data packet set is 1.

In one embodiment, the number of data packets included in the first data packet set is 2.

In one embodiment, the number of data packets included in the first data packet set is greater than 2. In one embodiment, the first data packet set includes only the second data packet.

In one embodiment, the number of data packets included in the first data packet set is no greater than 1024.

In one embodiment, the number of data packets included in the first data packet set is no greater than 65.

In one embodiment, data packets in the first data packet set arrive sequentially in time domain.

In one embodiment, the times at which data packets in the first data packet set arrive in time domain are non-overlapping.

In one embodiment, the times at which data packets in the first data packet set are transmitted in time domain are non-overlapping.

In one embodiment, the times at which data packets in the first data packet set are transmitted in time domain are overlapping.

In one embodiment, data packets in the first data packet set are transmitted sequentially in time domain.

In one embodiment, data packets in the first data packet set are transmitted simultaneously in time domain.

In one embodiment, data packets in the first data packet set arrive within a first time window.

In one subembodiment, the first time window is pre-defined.

In one subembodiment, the first time window is configured by signaling.

In one subembodiment, the first time window is configured by the first node by itself.

In one subembodiment, the first time window is determined by a QoS parameter of the first data packet set.

In one subembodiment, the first time window is determined by a QoS feature of the first data packet set.

In one subembodiment, the first data packet carries information about the first time window.

In one subembodiment, data packets in the first data packet set carry information about the first time window.

In one subembodiment, the first information indicates the first time window.

In one embodiment, data packets in the first data packet set are transmitted within a second time window.

In one subembodiment, the second time window is pre-defined.

In one subembodiment, the second time window is configured by signaling.

In one subembodiment, the second time window is configured by the first node by itself.

In one subembodiment, the second time window is determined by a QoS parameter of the first data packet set.

In one subembodiment, the second time window is determined by a QoS feature of the first data packet set.

In one subembodiment, the first data packet carries information about the second time window.

In one subembodiment, data packets in the first data packet set carry information about the second time window.

In one subembodiment, the second information indicates the second time window.

In one embodiment, the first time window and the second time window are of a same length.

In one embodiment, the first time window and the second time window are of different lengths.

In one embodiment, the first time window is longer than the second time window.

In one embodiment, as shown in FIG. 7, TO is a latest time that is allowable for any data packet in the first data packet set to be processed.

In one embodiment, as shown in FIG. 7, TO is a latest time that is allowable for any data packet in the first data packet set to be transmitted.

In one embodiment, as shown in FIG. 7, TO is a latest time that is allowable for any data packet in the first data packet set to be received by an application layer.

In one embodiment, as shown in FIG. 7, TO is a latest time that is allowable for the first data packet to be processed.

In one embodiment, as shown in FIG. 7, TO is a latest time that is allowable for the first data packet to be transmitted.

In one embodiment, as shown in FIG. 7, TO is a latest time that is allowable for the first data packet to be received by an application layer.

In one embodiment, as shown in FIG. 7, TO is a latest time that is allowable for the second data packet to be processed.

In one embodiment, as shown in FIG. 7, TO is a latest time that is allowable for the second data packet to be transmitted.

In one embodiment, as shown in FIG. 7, TO is a latest time that is allowable for the second data packet to be received by an application layer.

In one embodiment, the QoS information of the first data packet comprises the TO.

In one embodiment, the first information indicates the TO.

In one embodiment, the second information indicates the TO.

In one embodiment, QoS information of any data packet in the first data packet set comprises the TO.

In one embodiment, QoS information of any data packet in the first data packet set can determine the TO.

In one embodiment, any data packet that fails to be dealt with before TO in the first data packet set will be discarded.

In one embodiment, a requirement for delay of the QoS information of the first data packet comprises TO.

In one embodiment, a requirement for delay of the QoS information of the second data packet comprises TO.

### Embodiment 8

Embodiment 8 illustrates a schematic diagram of first information being used to indicate data packets included in a first data packet set according to one embodiment of the present application, as shown in FIG. 8.

In one embodiment, the first information explicitly indicates data packets included in the first data packet set.

In one embodiment, the first information indicates the number of data packets included in the first data packet set.

In one embodiment, the first information indicates sequence numbers of data packets included in the first data packet set.

In one embodiment, the first information indicates a start sequence number of data packets included in the first data packet set and the number of data packets included in the first data packet set.

In one embodiment, the first information indicates an end sequence number of data packets included in the first data packet set, and each data packet having been received with a sequence number no greater than the end sequence number belongs to the first data packet set.

In one subembodiment, the first information indicates a logical channel used by the first data packet set.

In one subembodiment, the first information indicates a radio bearer used by the first data packet set.

In one embodiment, the first information comprises an identifier or identity of the first data packet set, packets carrying the identifier or identity all belonging to the first data packet set.

In one embodiment, the first information is used to indicate an expiration value of the first timer.

In one embodiment, the first information is used to indicate priority/priorities of at least second data packet in the first data packet set.

In one embodiment, the first information is used to indicate type(s) of at least second data packet in the first data packet set.

In one embodiment, the first information indicates the second data packet, and the first data packet set includes only the second data packet.

In one embodiment, the first information indicates the second data packet, and the first data packet set includes only the first data packet and the second data packet.

In one embodiment, the first information is sent along with the first data packet.

In one embodiment, the first information is sent along with the second data packet.

In one embodiment, a copy of the first information is sent along with each packet in the first data packet set.

In one embodiment, the first information comprises a control signaling.

In one embodiment, the first information comprises a header of a data packet.

In one embodiment, the first information indicates one time window, and data packets transmitted within the one time window all belong to the first data packet set.

In one subembodiment, a start of the one time window is related to a reception time of the first information.

In one subembodiment, a start of the one time window is related to a transmission time of the first data packet.

In one subembodiment, a start of the one time window is related to a reception time of the first data packet.

In one subembodiment, the one time window is equal to one DRX cycle.

In one embodiment, the first information indicates one time window, and data packets received within the one time window all belong to the first data packet set.

In one subembodiment, the one time window is equal to one DRX cycle.

In one subembodiment, a start of the one time window is related to a reception time of the first information.

In one subembodiment, a start of the one time window is related to a transmission time of the first data packet.

In one subembodiment, a start of the one time window is related to a reception time of the first data packet.

In one embodiment, the first information indicates a cut-off time, and data packets received before the cut-off time all belong to the first data packet set.

In one embodiment, the first information comprises DCI.

In one embodiment, the first information comprises a MAC CE.

In one embodiment, the first information comprises SCI.

### Embodiment 9

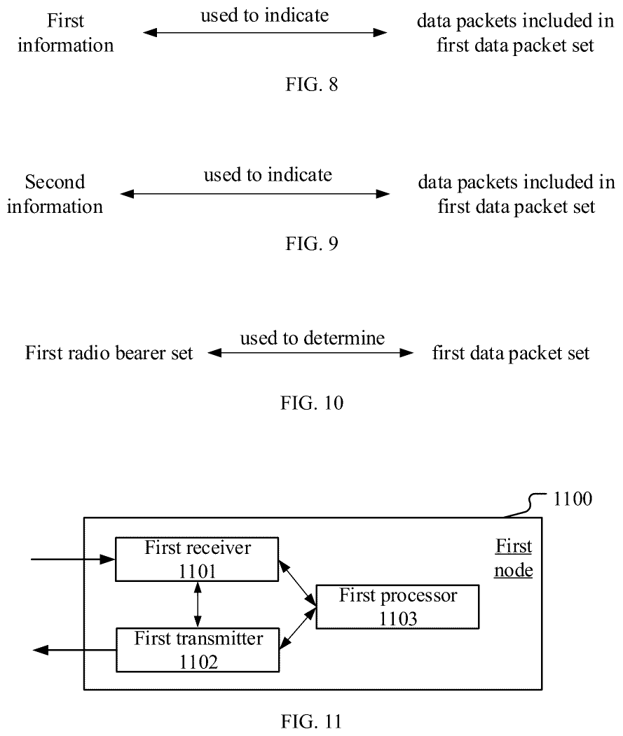

Embodiment 9 illustrates a schematic diagram of second information being used to indicate data packets included in a first data packet set according to one embodiment of the present application, as shown in FIG. 9.

In one embodiment, the second information explicitly indicates data packets included in the first data

packet set.

In one embodiment, the second information indicates the number of data packets included in the first data packet set.

In one embodiment, the second information indicates sequence numbers of data packets included in the first data packet set.

In one embodiment, the second information indicates a start sequence number of data packets included in the first data packet set and the number of data packets included in the first data packet set.

In one embodiment, the second information indicates an end sequence number of data packets included in the first data packet set, and each data packet having been received with a sequence number no greater than the end sequence number belongs to the first data packet set.

In one subembodiment, the second information indicates a logical channel used by the first data packet set.

In one subembodiment, the second information indicates a radio bearer used by the first data packet set.

In one embodiment, the second information comprises an identifier or identity of the first data packet set, packets carrying the identifier or identity all belonging to the first data packet set.

In one embodiment, the second information is used to indicate an expiration value of the first timer.

In one embodiment, the second information is used to indicate priority/priorities of at least second data packet in the first data packet set.

In one embodiment, the second information is used to indicate type(s) of at least second data packet in the first data packet set.

In one embodiment, the second information indicates the second data packet, and the first data packet set includes only the second data packet.

In one embodiment, the second information indicates the second data packet, and the first data packet set includes only the first data packet and the second data packet.

In one embodiment, the second information is sent along with the first data packet.

In one embodiment, the second information is sent along with the second data packet.

In one embodiment, a copy of the second information is sent along with each packet in the first data packet set.

In one embodiment, the second information comprises a control signaling.

In one embodiment, the second information comprises a header of a data packet.

In one embodiment, the second information indicates one time window, and data packets transmitted within the one time window all belong to the first data packet set.

In one subembodiment, a start of the one time window is related to a reception time of the second information.

In one subembodiment, a start of the one time window is related to a transmission time of the first data packet.

In one subembodiment, a start of the one time window is related to a reception time of the first data packet.

In one subembodiment, the one time window is equal to one DRX cycle.

In one embodiment, the second information indicates one time window, and data packets received within the one time window all belong to the first data packet set.

In one subembodiment, a start of the one time window is related to a reception time of the second information.

In one subembodiment, a start of the one time window is related to a transmission time of the first data packet.

In one subembodiment, a start of the one time window is related to a reception time of the first data packet.

In one subembodiment, the one time window is equal to one DRX cycle.

In one embodiment, the second information indicates a cut-off time, and data packets received before the cut-off time all belong to the first data packet set.

In one embodiment, the second information comprises a MAC CE.

In one embodiment, the second information comprises SCI.

In one embodiment, reception of the first information triggers transmission of the second information.

In one embodiment, the second information is used to indicate a largest delay allowable for the first data packet set.

### Embodiment 10

Embodiment 10 illustrates a schematic diagram of a first radio bearer set being used to determine a first data packet set according to one embodiment of the present application, as shown in FIG. 10.

In one embodiment, the first node receives third information, the third information indicating a first radio bearer set, the first radio bearer set including at least one radio bearer, the first radio bearer set being used to determine the first data packet set.

In one embodiment, the third information comprises an RRC message.

In one embodiment, the first radio bearer set includes only one radio bearer.

In one embodiment, all radio bearers included in the first radio bearer set are DRBs.

In one embodiment, all radio bearers included in the first radio bearer set are DRBs and MRBs.

In one embodiment, the first radio bearer set includes at least two DRBs.

In one embodiment, the first data packet and the second data packet use different DRBs.

In one embodiment, the first data packet and the second data packet use a same DRB.

In one embodiment, the first data packet and the second data packet use a same MRB.

In one subembodiment, one of the first data packet and the second data packet uses a PTM branch of the MRB and the other uses a PTP branch of the MRB.

In one embodiment, data packets transmitted on radio bearers in the first radio bearer set all belong to the first data packet set.

In one embodiment, data packets received on radio bearers in the first radio bearer set all belong to the first data packet set.

In one embodiment, data packets transmitted within a first time window on radio bearers in the first radio bearer set all belong to the first data packet set.

In one subembodiment, the third information indicates the first time window.

In one subembodiment, the one time window is one DRX cycle.

In one embodiment, data packets transmitted before a certain cut-off time on radio bearers in the first radio bearer set all belong to the first data packet set.

In one subembodiment, the third information indicates the certain cut-off time.

In one embodiment, data packets whose packet headers include a particular field on radio bearers in the first radio bearer set all belong to the first data packet set.

In one subembodiment, the header including a particular field is used to indicate the first data packet set.

In one embodiment, data packets whose packet headers have a field with a value being a particular value on radio bearers in the first radio bearer set all belong to the first data packet set.

In one subembodiment, the value of one field of the header is used to indicate the first data packet set.

### Embodiment 11

Embodiment 11 illustrates a structure block diagram of a processing device used in a first node according to one embodiment of the present application, as shown in FIG. 11. In FIG. 11, a processing device 1100 in the first node comprises a first receiver 1101, a first transmitter 1102 and a first processor 1103. In Embodiment 11,

the first processor 1103 performs a first operation for a first data packet at a first protocol layer, the first operation being receiving, or the first operation being transmitting: as a response to the action of performing the first operation, starts a first timer, and as a response to expiration of the first timer, performs a second operation for at least second data packet in a first data packet set at the first protocol layer: the second operation being submitting to a protocol layer other than the first protocol layer, or the second operation being discarding:

herein, the first data packet is different from the second data packet: the first data packet and any data packet in the first data packet set are data packets for a user plane; and the first data packet and any data packet in the first data packet set are both generated at the first protocol layer: the first protocol layer is a protocol layer above a Media Access Control (MAC) layer: at least part of bits of the first data packet are transmitted via a Data Radio Bearer (DRB).

In one embodiment, whether the first operation is receiving or transmitting is used to determine the second operation: when the first operation is receiving, the second operation is submitting to a second protocol layer; when the first operation is transmitting, the second operation is submitting to a third protocol layer or discarding.

In one embodiment, the first data packet and the second data packet use different Data Radio Bearers (DRBs).

In one embodiment, the first data packet includes a first identifier; a target data packet is any data packet in the first data packet set, and whether the target data packet includes the first identifier is used to determine whether to perform the second operation for the target data packet: when the target data packet includes the first identifier, the second operation is performed for the target data packet: when the target data packet does not include the first identifier, the second operation is not performed for the target data packet.

In one embodiment, the first receiver 1101 receives first information, the first information being used to indicate data packets included in the first data packet set.

In one embodiment, the time of expiration of the first timer is related to either of the time of transmission of the second data packet or the time of arrival of a SDU of the second data packet.

In one embodiment, the first transmitter 1102 transmits second information, the second information being used to indicate data packets included in the first data packet set.

In one embodiment, the first receiver 1101 receives third information, the third information indicating a first radio bearer set, the first radio bearer set including at least one radio bearer, the first radio bearer set being used to determine the first data packet set.

In one embodiment, the first node is a UE.

In one embodiment, the first node is a terminal supporting large delay difference.

In one embodiment, the first node is a terminal supporting NTN.

In one embodiment, the first node is an aircraft or vessel.

In one embodiment, the first node is a cellphone or vehicle-mounted terminal.

In one embodiment, the first node is a relay UE and/or a U2N remote UE.

In one embodiment, the first node is an IoT terminal or IIoT terminal.

In one embodiment, the first node is a piece of equipment supporting transmissions with low delay and high reliability.

In one embodiment, the first node is a sidelink communication node.

In one embodiment, the first node is a base station.

In one embodiment, the first node is a satellite.

In one embodiment, the first node is an access network device.

In one embodiment, the first receiver 1101 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1102 comprises at least one of the antenna 452, the transmitter 454, the transmitting processor 468, the multi-antenna transmitting processor 457, the controller/processor 459, the memory 460 or the data source 467 in Embodiment 4.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally; all or part of steps in the above embodiments also may be implemented by one or more integrated circuits.

Correspondingly; each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (IoT), RFID terminals, NB-IoT terminals, Machine Type Communication (MTC) terminals, enhanced MTC (eMTC) terminals, data cards, low-cost mobile phones, low-cost tablet computers, satellite communication equipment, ship communication equipment, and NTN UE, etc. The base station or system device in the present application includes but is not limited to macro-cellular base stations, micro-cellular base stations, home base stations, relay base station, gNB

(NR node B), Transmitter Receiver Point (TRP), NTN base station, satellite equipment and fight platform, and other radio communication equipment.

This disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first processor, performing a first operation for a first data packet at a first protocol layer, the first operation being transmitting: as a response to the action of performing the first operation, starting a first timer, and as a response to expiration of the first timer, performing a second operation for at least second data packet in a first data packet set at the first protocol layer; the second operation being discarding:
wherein the first data packet is different from the second data packet: the first data packet and any data packet in the first data packet set are data packets for a user plane; and the first data packet and any data packet in the first data packet set are both generated at the first protocol layer: the first protocol layer is a protocol layer above a Media Access Control (MAC) layer: at least part of bits of the first data packet are transmitted via a Data Radio Bearer (DRB).

2. The first node according to claim 1, characterized in that the first data packet is a PDCP PDU; and the second data packet is a PDCP PDU.

3. The first node according to claim 1, characterized in that the first data packet and the second data packet use different DRBs.

4. The first node according to claim 1, characterized in that the first data packet includes a first identifier: a target data packet is any data packet in the first data packet set, and whether the target data packet includes the first identifier is used to determine whether to perform the second operation for the target data packet: when the target data packet includes the first identifier, the second operation is performed for the target data packet: when the target data packet does not include the first identifier, the second operation is not performed for the target data packet.

5. The first node according to claim 2, characterized in that the first data packet includes a first identifier; a target data packet is any data packet in the first data packet set, and whether the target data packet includes the first identifier is used to determine whether to perform the second operation for the target data packet: when the target data packet includes the first identifier, the second operation is performed for the target data packet: when the target data packet does not include the first identifier, the second operation is not performed for the target data packet.

6. The first node according to claim 1, characterized in comprising:
the first timer being a discardTimer.

7. The first node according to claim 2, characterized in that the first timer is a discardTimer.

8. The first node according to claim 4, characterized in that the first timer is a discardTimer.

9. The first node according to claim 5, characterized in that the first timer is a discardTimer.

10. The first node according to claim 1, characterized in comprising:
a first transmitter, transmitting second information, the second information being used to indicate data packets included in the first data packet set.

11. The first node according to claim 1, characterized in comprising:
a first receiver, receiving third information, the third information indicating a first radio bearer set, the first radio bearer set including at least one radio bearer, the first radio bearer set being used to determine the first data packet set.

12. The first node according to claim 1, characterized in comprising:
a first transmitter, transmitting second information, the second information indicating a time T0, the T0 being the latest time at which the first data packet is allowed to be transmitted: the second information being a MAC Control Element (CE).

13. The first node according to claim 7, characterized in comprising:
a first transmitter, transmitting second information, the second information indicating a time T0, the T0 being the latest time at which the first data packet is allowed to be transmitted: the second information being a MAC Control Element (CE).

14. The first node according to claim 9, characterized in comprising:
a first transmitter, transmitting second information, the second information indicating a time T0, the T0 being the latest time at which the first data packet is allowed to be transmitted: the second information being a MAC Control Element (CE).

15. The first node according to claim 1, characterized in comprising:
the first processor, discarding any data packet in the first data packet set.

16. The first node according to claim 2, characterized in comprising:
the first processor, discarding any data packet in the first data packet set.

17. The first node according to claim 7, characterized in comprising:
the first processor, discarding any data packet in the first data packet set.

18. A method in a first node for wireless communications, comprising:
performing a first operation for a first data packet at a first protocol layer, the first operation being transmitting; as a response to the action of performing the first operation, starting a first timer, and as a response to expiration of the first timer, performing a second operation for at least second data packet in a first data packet set at the first protocol layer; the second operation being discarding;
wherein the first data packet is different from the second data packet; the first data packet and any data packet in the first data packet set are data packets for a user plane; and the first data packet and any data packet in the first data packet set are both generated at the first protocol layer; the first protocol layer is a protocol layer above a Media Access Control (MAC) layer; at least part of bits of the first data packet are transmitted via a Data Radio Bearer (DRB).

19. The method in the first node according to claim 18, characterized in that
the first data packet is a PDCP PDU; and the second data packet is a PDCP PDU.

20. The method in the first node according to claim 18, characterized in that
the first timer is a discardTimer.
